(19) United States
(12) Patent Application Publication
(10) Pub. No.: US 2014/0050588 A1
(43) Pub. Date: Feb. 20, 2014

(54) DEVICE FOR USING WIND POWER HAVING AT LEAST ONE ROTOR

(71) Applicant: Siegfried Schmitt, Altstatten (CH)

(72) Inventor: Siegfried Schmitt, Altstatten (CH)

(21) Appl. No.: 14/002,719

(22) PCT Filed: Feb. 23, 2012
(86) PCT No.: PCT/DE2012/000181

§ 371 Date: Oct. 31, 2013

(30) Foreign Application Priority Data
Mar. 2, 2011 (DE) 20 2011 003 442.9

(51) Int. Cl. F03D 3/06

(52) U.S. Cl. CPC F03D 3/061
USPC 416/197 A

(57) ABSTRACT

For a device for using wind power having at least one rotor, wherein the rotor has a rotor shaft having a vertically arranged rotational axis and at least three support frames each having at least one rotor blade are arranged on the rotor shaft and the rotor blades are offset from each other by the same angle in the rotational direction of the rotor, the rotor blades are arranged at a radial distance from the rotor shaft. At least one wind passage is formed between the rotor shaft and each of the rotor blades. Thus a device having high efficiency is created.

The invention relates to a device for using wind power having at least one rotor, wherein the rotor has a rotor shaft having a vertically arranged axis of rotation, at least three support frames each having at least one rotor blade are arranged on the rotor shaft and the rotor blades are offset from each other by the same angle in the direction of rotation of the rotor shaft.

As a result of the higher efficiencies compared with other embodiments, wind power systems having the axis of rotation of the rotor lying in the wind direction, so-called horizontal axis rotors, have largely gain acceptance over those having a vertical axis of rotation of the rotor. However, with the increasingly widespread use of horizontal axis rotors, the disadvantages thereof are also having an effect such as a periodic casting of shadows by the moving rotor blades and evolution of noise in particular caused by the high circumferential speeds of the outer blade tips. Both the casting of shadows and also the evolution of noise of these wind power systems are frequently perceived as troublesome by residents particularly in the vicinity of settlement areas, with the result that authorisation procedures for new systems are frequently made difficult.

Along with the erection of offshore systems having horizontal axis rotors, one approach to avoiding problems could lie in the use of rotors having a vertical axis of rotation designed as resistance rotors.

Whereas most vertical axis rotors designed as propulsion rotors cause noise and periodic casting of shadows similar to the widely used horizontal axis rotors, these shortcomings with resistance rotors are usually not important. However, the known resistance-drive devices having a vertical axis of rotation have a very low resistance which so far conflicts with economic operation. The low efficiency is frequently caused by the fact that along with the inflow surfaces of the rotor blades, the wind impinging upon the rotor blades always presses onto the rear sides of the rotor blades rotating contrary to the wind and only flows off inadequately at these sides. Attempts are therefore made inter alia to divert or deflect the air flow with housings arranged partially around the rotors but the disadvantage here is that the wind can only be intercepted from one direction.

It is the object of the invention to provide a device for using wind power having a vertical axis of rotation in which the said disadvantages are avoided and which has a higher efficiency compared with previous resistance rotors having a vertical axis of rotation.

The solution of this object is accomplished with a device according to claim 1. Further developments and advantageous configurations of the device are given in the subclaims 2 to 11.

In a device for using wind power having at least one rotor, where the rotor has a rotor shaft having a vertically arranged axis of rotation, at least three support frames each having at least one rotor blade are arranged on the rotor shaft and the rotor blades are offset from each other by the same angle in the direction of rotation of the rotor shaft, it is provided according to the invention that the rotor blades are arranged at a radial distance from the rotor shaft, where at least one wind passage is formed between the rotor shaft and the rotor blades. The wind passages have the result that during operation of the device the resistance to the wind from the rotor blades having wind flowing onto the rear side, is reduced compared with rotor blades resting on the rotor shaft. The wind impinging upon the rotor blades having wind flowing onto the rear side can then flow off more favourably on both sides, that is both on the side facing the rotor shaft and on the side facing away from the rotor shaft. Since the wind impinging upon the rotor blades rotating in the wind direction is “intercepted” unchanged by these rotor blades, the rotor according to the invention has an overall improved flow profile at the rotor blades with a particularly favourable ratio of pressure to counterpressure. The efficiency of the system is particularly favourable as a result.

In order to ensure that the wind passages are sufficiently dimensioned, it is provided that the surface areas of the wind passages between the rotor blades and the rotor shaft are in each case at least a quarter of the surfaces areas of the rotor blades, in particular in each case at least half the surface area of the rotor blades. These dimensions ensure that the air deflected from the rotor blades having wind flowing onto the rear side can be diverted in an optimal manner and without accumulations of air by the rotor blades.

In vertical extension, the wind passages formed between the rotor blades and the rotor shaft are advantageously delimited in each case by a support arm of the supporting frame. To this end, each support frame for a rotor blade advantageously has two support arms between which the rotor blades are held. The surface areas of the wind passage are therefore as large as possible. In addition, air turbulence is avoided as a result of struts of the support frame. The rotor blade held on the respective support arm is at the same time optimally fixed, a simply designed and light support frame being provided.

The device can have particularly compact dimensions if the rotor blades are arranged in a plane perpendicular to the axis of rotation of the rotor. The space available around the circumference of the rotor shaft is therefore optimally utilised. Ideally at least three rotor blades are therefore arranged in one plane. The distance or angle between the rotor blades should be the same as far as possible and with three rotor blades is preferably 120°. A minimum distance of the rotor blades to one another should possibly be determined depending on turbulence of the wind.

The stability of the support frame of a rotor blade or individual support parts can be increased whereby all the support arms of support frames arranged in a plane perpendicular to the axis of rotation of the rotor are formed as a one-piece component. A strongly direction-dependent changing loading of the rotor or individual support arms or support frame can be effectively counteracted since the forces produced by the wind and acting on the device are distributed on the entire component. In order to prevent icing in appropriate weather, the rotor blades and/or support frame can also be designed to be heatable.

In particular, the counterpressure acting on the rotor blades having wind flowing onto the rear side can be minimised by a fluidically favourable configuration of the rotor blades. To this end it is provided that the rotor blades are configured as horizontal cups which each have at least one cup opening opposite the direction of rotation of the axis of rotation of the rotor. During operation of the device the wind presses into the cup having the cup opening standing open towards the wind and is deflected at the other cups. The air flowing into the cups is intercepted and builds up pressure in the cup or cups which is converted into a rotational movement of the rotor. In this case, the pressure in the respective cups exceeds the counterpressure acting on the outer surfaces of the cups.

An optimisation of the cups consists in that these have the shape of pyramids with convexly curved lateral surfaces, where the base area of the pyramids is configured as a cup opening. This shape is very close to the advantageous flow behaviour at a sphere so that the wind impinging upon the convexly curved outer lateral surfaces can flow off from these in an optimal manner.

At the same time, the base area of the pyramids creates a large inflow surface with which as much wind as possible can be intercepted to produce pressure to propel the rotor. The pyramid-shaped rotor blades can additionally be fixed in a simple manner to the respective support frame since the edges of the base area or cup opening parallel to the respective support arms rest on these. Preferably the base area of the pyramid configured as a cup opening has a rectangular shape. The rectangular shape has the largest possible inflow surface for the same height compared with, for example, a square or circular base area.

The torque which can be produced with the device can be increased by an optimised wind load distribution on the rotor blades. To this end it is provided that the rotor blades have an asymmetric curvature with a wind load focus arranged offset towards the outside from the centre thereof. The wind load focus is dependent on the shape of the rotor blade and when a cup or pyramid is formed, is usually on the deepest area of the cup or of the pyramid. Since the torque increases with the distance from the rotor shaft, the deepest point of the cup of the rotor blades should be arranged at the greatest possible distance from the rotor shaft. This large distance is achieved with the asymmetric curvature without increasing the dimensions of the rotor itself.

According to a further development it is provided that the rotor has support frames with rotor blades in at least two planes configured perpendicular to its axis of rotation so that a plurality of rotor blades are arranged one above the other on the rotor shaft which is inclined at a different angle to the axis of rotation. As a result, overall more rotor blades than in only one plane can be provided without the rotor blades being negatively influenced by wind turbulence which may occur. In addition, the torque which can be transferred to a generator coupled to the rotor shaft is increased by a higher number of rotor blades. The amount of current or power of the rotor which can be generated with the device can therefore be increased depending on the number of rotor blades.

A further advantage of many rotor blades is that imbalances which may occur during operation of the device are reduced and therefore direction-dependent changing loads acting on the rotor are avoided. At the same time, it is achieved that a torque produced by the rotation of the rotor is subjected to fewer fluctuations.

In order to ensure a high stability of the device, according to another further development it is provided that the rotor shaft of the rotor is disposed in a support mast. With the support mast the device can be arranged at a greater height for example in order to utilise stronger winds. Furthermore a plurality of rotors can be arranged in a support mast to utilise wind power.

An exemplary embodiment of the invention is shown in the drawing. In the figures:

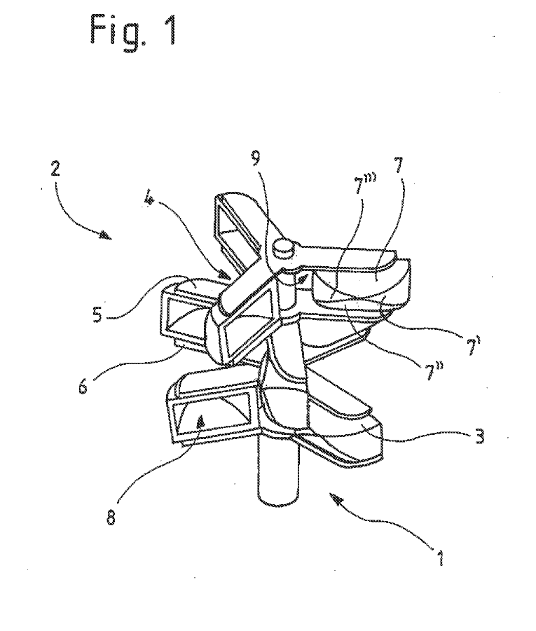

FIG. 1: shows a device for using wind power in perspective view;

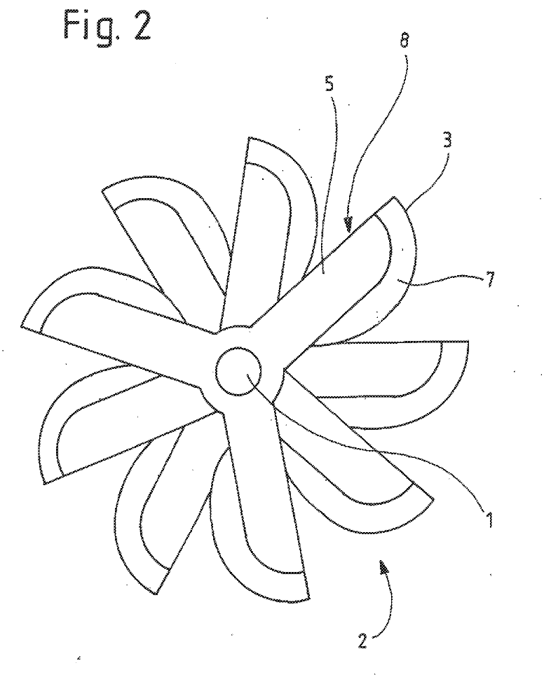

FIG. 2: shows the device for using wind power in plan view; and

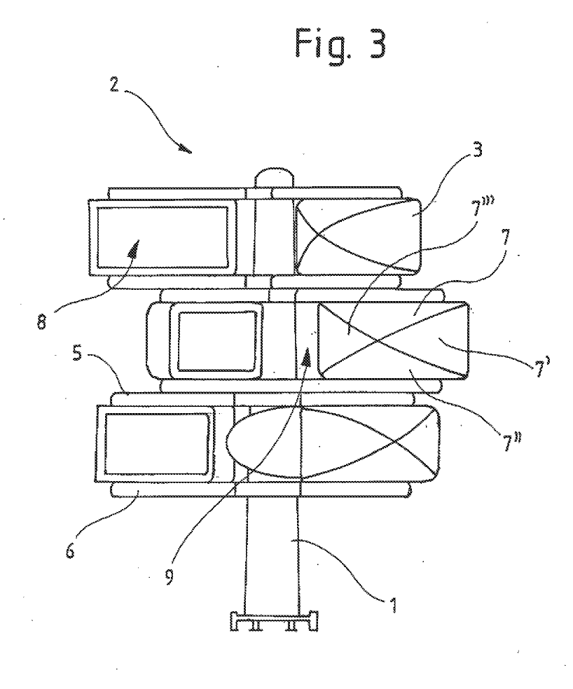

FIG. 3: shows the device for using wind power in side view.

The device shown in FIG. 1 has a support mast 1 with a rotor 2, where the rotor 2 has a vertical axis of rotation. Rotor blades are arranged on the support mast 1 in three planes perpendicular to the support mast 1. Three rotor blades 3 are assigned to each of the three planes so that overall nine rotor blades 3 are arranged on the support mast 1. These rotor blades 3 are each held in a support frame 4 where each support frame 4 is composed of a first upper support arm 5 and a second lower support arm 6. The support arms 5 or 6 consists of a one-piece component in respectively one plane perpendicular to the support mast 1. Overall the device therefore has three one-piece components for the upper support arms 5 and three one-piece components for the lower support arms 6.

The rotor blades 3 each have four rectangular lateral surfaces 7, 7′, 7″, 7″′ which form a pyramid whose tip points in the direction of rotation of the rotor, where the lateral surfaces 7, 7′, 7″, 7″′ are convexly curved in such a manner that the rotor blades 3 have a rounded profile both in the plan view and in the side view. Each of the pyramid-shaped rotor blades 3 therefore corresponds to a cup formed by the lateral surfaces 7, 7′, 7″, 7″′, where the base area of the pyramids is configured as a cup opening 8 and delimits an inflow surface formed on the inner walls of the lateral surfaces 7, 7′, 7″, 7″′. The cup opening 8 extends in the vertical direction and perpendicular to the axis of rotation of the rotor 2. Air flowing in via the cup opening 8 therefore exerts pressure inside the rotor blades 3.

Respectively one wind passage 9 is formed between the support mast 1 and the lateral surfaces 7″′ of the rotor blades 3 which is delimited at the top by the respective support arm 5 and at the bottom by the respective support arm 6. These wind passages 9 ensure that the air flowing away from the lateral surfaces 7, 7′, 7″, 7″′ can be led off in an optimal manner without accumulations.

The rounded profile of the rotor blades 3 is particularly clear in FIG. 2. In addition, the component, formed in one piece, of the upper support arms 5 of the uppermost plane of rotor blades 3 as well as the arrangement of rotor blades 3 of one plane in each case at an angle of 120° to one another can be seen. In each case angles of at least 40° are provided between the rotor blades in the various planes. Each rotor blade 3 is therefore arranged at a different angle to the axis of rotation of the rotor 2.

FIG. 3 shows that the upper and lower support arms 5, 6 are arranged between two planes of rotor blades 3 with the shortest possible distance above one another on the support mast 1. The cup openings of the rotor blades 3 are each rectangular-shaped, where the lateral surfaces 7 or 7″ of the rotor blades 3 abut against the support arms 5 or 6 and at the same time delimit the cup opening 8 at the top or bottom. Furthermore, the surface areas of the wind passages 9 between the support mast 1 and the rotor blades 3 can be identified.

If wind now flows onto the rotor blades 3, the wind presses into at least four cups of the rotor blades 3. In this case, the pressure produced on the rotor blades 3 having flow onto the lateral surfaces 7, 7′, 7″, 7″′ is lower than the pressure in the rotor blades 3 so that the rotor begins to turn in its direction of rotation. The rotational movement produced is transferred inside the support mast 1 to a rotor shaft to which a generator can then be coupled.

1. A device for using wind power comprising at least one rotor, wherein the rotor has a rotor shaft having a vertically arranged axis of rotation and at least three support frames each having at least one rotor blade are arranged on the rotor shaft wherein the rotor blades are offset from each other by the same angle in the direction of rotation of the rotor shaft, the rotor blades are arranged at a radial distance from the rotor shaft, wherein at least one wind passage is formed between the rotor shaft and the rotor blades, that each support frame for a rotor blade has two support arms between which the rotor blade is held, wherein the respective surface area of the wind passage is delimited by the support arms and the rotor blades are configured as horizontal cups which each have at least one cup opening opposite the direction of rotation of the axis of rotation of the rotor.

2. The device according to claim 1, wherein the surface areas of the wind passages between the rotor blades and the rotor shaft each amount to at least a quarter of the surface area of the rotor blades.

3. The device according to claim 1, wherein the rotor blades are arranged in a plane perpendicular to the axis of rotation of the rotor.

4. The device according to claim 2, wherein all the support arms arranged in a plane perpendicular to the axis of rotation of the rotor are configured as a one-piece component.

5. The device according to claim 1, wherein the cups have the form of a pyramid with convexly curved outer surfaces (7, 7′, 7″, 7″′), where in the base surface of the pyramid is configured as a cup opening.

6. The device according to claim 1, wherein each of the at least one cup opening has a rectangular shape.

7. The device according to claim 1, wherein the rotor blades have an asymmetric curvature with a wind load focus arranged offset towards the outside from the centre thereof.

8. The device according to claim 1, wherein the rotor has support frames with rotor blades in at least two planes configured perpendicular to its axis of rotation.

9. The device according to claim 1, wherein the rotor shaft of the rotor is arranged in a supporting mast.

10. The device according to claim 9, wherein several rotors are arranged on the supporting mast.
